(19) United States
(12) Patent Application Publication
(10) Pub. No.: US 2012/0076232 A1
(43) Pub. Date: Mar. 29, 2012

(54) Coder and Decoder, Coding Method and Decoding Method, and System Comprising a Coder and a Decoder

(75) Inventor: Eberhard SCHMIDT, Bremen (DE)

(73) Assignee: Atlas Elektronik GmbH, Bremen (DE)

(21) Appl. No.: 13/240,277

(22) Filed: Sep. 22, 2011

(30) Foreign Application Priority Data
Sep. 25, 2010 (EP) 10 400047.6

(51) Int. Cl. H04L 27/00

(52) U.S. Cl. 375/295

(57) ABSTRACT

A coder (36) for mapping a digital signal (10) into a transmission signal (12) and a decoder (44) for mapping a reception signal (13) into a digital signal (10) for transmission by and reception from a real channel (42), respectively. The coder (36) allocates code symbols (16) of a code space (40) to data symbols (14) of the digital signal (12) and generates the transmission signal (12) The decoder (44) detects the code symbols (16) on the basis of the reception signal (13) and allocates data symbols (14) of the digital signal (10) to the code symbols (16) of the code space (40). The data symbols (12) each have at least two bits (18) of the digital signal (10), and the code space (40) comprises code symbols (16) of two groups (38, 39).

### CROSS-REFERENCE TO RELATED APPLICATION

The present application claims the priority of European patent Application No. 10400047.6, filed Sep. 25, 2010, the subject matter of which, in its entirety, is incorporated herein by reference.

### BACKGROUND OF THE INVENTION

The invention relates to a coder for mapping a digital signal into a transmission signal and to a coding method for this purpose, and to a decoder for mapping a signal transmitted as a transmission signal and received as a reception signal into a digital signal and to a decoding method for this purpose. The invention also relates to a system comprising a coder for mapping a digital signal into a transmission signal and a decoder for mapping a signal transmitted as a transmission signal and received as a reception signal into a digital signal.

In the field of signal transmission, digital signals are often transmitted at high data rates over long distances using long lines, for example electrical lines. One example of this is the transmission of digital signals in or under water. In this case, radio transmission over long distances is usually very complicated or even impossible on account of the attenuation properties. In particular, in the case of radio transmission under water at high frequencies in order to transmit high data rates, the attenuation properties of the water are greater in comparison with lower frequencies.

During underwater sound location, emitted noises or reflected sound waves are received using an antenna, for example a towed antenna. For this purpose, the antenna has a multiplicity of transducers, for example electroacoustic transducers, which convert the sound waves into electrical signals, as well as signal processing units which are each assigned to the respective transducers, preprocess the electrical transducer signals and convert them into digital signals. A central signal processing device which is arranged in the hull evaluates the digital signals from the signal processing unit assigned to the transducer and processes them further. Particular antennas for underwater sound location, such as towed antennas, are spatially spread far apart in order to be able to pick up low frequencies at the wavelengths prevailing in the water, for example. Owing to this spread, long lines are essential between the transducers and the central signal processing device.

For transmission on the line which can also be referred to as a real channel, the digital signal is mapped to a transmission signal in a coder provided in the respective signal processing unit. After transmission, the received transmission signal, that is to say the reception signal, is mapped to the digital signal again in a decoder provided in the central signal processing device. According to the prior art, the coding and decoding operations are carried out according to the non-return-to-zero method.

In addition to the non-return-to-zero method, US 2009/0243688 A1 shows a system and a method for converting a digital signal into a transmission signal which can be transmitted in a real channel. In this case, the digital signal corresponds to a pulse-code-modulated signal (PCM signal) consisting of a binary sequence of bits and the transmission signal corresponds to a pulse-width-modulated signal (PWM signal). The conversion can be compared with the abovementioned coding.

EP 1 376 875 A2 also shows an apparatus and a method for converting a digital signal into a PWM signal. Further methods and apparatuses for converting or coding a digital signal into a PWM signal are also shown in “A novel and efficient PCM to PWM converter for digital audio amplifiers”, Andres C., Floros, John N. Mourjopoulos, University of Patras, and in “Digital power amplification based on pulse-width modulation and sigma-delta loops. A comparison of current solutions”, R. Esslinger, R. W. Stewart, University of Strathclyde, R. W. Stewart, Fachhochschule Heilbronn.

In the conventional design of the non-return-to-zero method for coding and decoding, data symbols are formed from the digital signal. In this case, each bit of the digital signal corresponds exactly to one data symbol, thus resulting in exactly two different data symbols with the binary values “0” and “1”. Furthermore, code symbols with respective different potential levels are defined. In order to be able to allocate a defined code symbol to each different data symbol, two different code symbols are defined according to the different data symbols in the case of the non-return-to-zero method. These two different code symbols form a so-called code space. The first code symbol of the code space is defined as a low potential level, for example, and the second code symbol is defined as a high potential level, for example.

For transmission, the code symbol corresponding to the data symbol is respectively allocated to the data symbols formed from the digital signal in the coder. The transmission signal is then generated on the basis of the code symbols.

In a similar manner to the coder, code symbols are detected on the basis of a reception signal and are each allocated to the corresponding data symbols in a decoder. The digital signal is finally formed again from the data symbols.

In the simplest case, the transmission signal is generated in the coder on the basis of the code symbols by producing the potential level of the code symbols on the line. A high potential level may be produced as 5 V, for example, and a low potential level may be produced as 0 V, for example, on the line. The code symbols are detected in the decoder on the basis of the reception signal by measuring the potential level of the line and detecting the code symbol therefrom.

The non-return-to-zero method is based on a clock frequency. With each clock pulse of the clock frequency, the transmission signal is generated on the basis of the potential level of a code symbol and one bit of the digital signal is thus mapped into the transmission signal. Signal edges also occur between code symbols with different potential levels. It is possible to determine the interval of time between successive signal edges, which is referred to as the edge spacing.

A minimum edge spacing is defined by the period duration corresponding to the clock frequency. This minimum edge spacing corresponds to the interval of time between two signal edges which occur when code symbols each having different potential levels follow one another. The bit string “010” of a digital signal could be considered by way of example here. This results in a data symbol with the binary value “0”, a data symbol with the binary value “1” and a further data symbol with the binary value “0”. The code symbols are accordingly allocated to the data symbols, thus resulting in a code symbol with a low potential level followed by a code symbol with a high potential level again followed by a code symbol with a low potential level. In this example, two signal edges of the three code symbols are produced, the spacing of which is referred to as the minimum edge spacing. A smaller edge spacing cannot occur since the potential level of the code symbols changes at most once per clock pulse.

When transmitting digital signals using the non-return-to-zero method, adjacent signal edges with the abovementioned minimum edge spacing determined by the clock frequency and with edge spacings which correspond to the integer multiple of the minimum edge spacing thus occur.

In the non-return-to-zero method, the bit rate, namely the number of bits which can be transmitted per second, is thus dependent on the clock frequency or the period duration. The bit rate is limited by the fact that the line, for instance an electrical line, has real physical properties for transmission and can thus be considered to be a real channel. On account of the line capacitance of an electrical line, for example, the signal edges between the potential changes rise and fall with a flat profile.

If the bit rate is now intended to be increased, the shortening of the period duration of the clock pulse results in the occurrence of a minimum edge spacing which is so short that the signal edges of the transmission signal which are generated from the code symbols do not reach a target potential level, as a result of the flat rise and fall of the line capacitance on the electrical line, before the next signal edge follows in the opposite direction. When receiving this transmission signal received as a reception signal, the problem of no different potential levels being detected even though they have been produced arises in a decoder.

Yet other methods are known but they are all based on the principle of transmitting at most one bit per clock pulse. If a clock rate with a minimum edge spacing, which can still be transmitted without errors with respect to the line capacitance, is used for this purpose, the frequency taken as a basis in known methods is precisely the measure for determining the maximum bit rate.

If the bit rate is thus intended to be increased on an electrical line above the maximum bit rate made possible by the non-return-to-zero method, for example, this results in error-prone transmission of the digital signal.

The invention is therefore based on the object of increasing the maximum transmission bit rate in a real channel in comparison with known methods.

### SUMMARY OF THE INVENTION

The above object is generally achieved according to a first aspect of the invention by a coder for mapping a digital signal into a transmission signal for transmission in a real channel, with the coder being designed to allocate code symbols of a code space to data symbols of the digital signal by respectively assigning a code symbol to the data symbols and to generate the transmission signal on the basis of the code symbols, and with the transmission signal having signal edges that consist of the transition from one potential level to another potential level, and edge spacings defined by the interval of time between at least two identical or predetermined different potentials of adjacent signal edges. The data symbols each have two or more bits of the digital signal, and the code space comprises code symbols of two groups, with each code symbol having one or a plurality of edge spacings, and wherein
a) the edge spacing or each of the edge spacings corresponds to the minimum edge spacing in the first group, and
b) the edge spacing or one, a plurality of or all of the plurality of edge spacings correspond to one or more integer multiples plus a fraction of an integer multiple of the minimum edge spacing in the second group.

The above object is generally achieved according to a second aspect of the invention by a coding method for mapping a digital signal into a transmission signal for transmission in a real channel, with code symbols of a code space being allocated to data symbols of the digital signal by respectively assigning a code symbol to the data symbols, and with the transmission signal being generated on the basis of the code symbols. The transmission signal having signal edges that consist of the transition from one potential level to another potential level, and edge spacings defined by the interval of time between at least two identical or predetermined different potentials of adjacent signal edges. The data symbols each have two or more bits of the digital signal, and the code space comprises code symbols of two groups, with each code symbol having one or a plurality of edge spacings, wherein
a) the edge spacing or each of the edge spacings corresponds to the minimum edge spacing in the first group, and
b) the edge spacing or one, a plurality of, or all of the plurality of edge spacings corresponds to one or more integer multiples plus a fraction of an integer multiple of the minimum edge spacing in the second group.

The above object is generally achieved according to a third aspect of the invention by a decoder for mapping a signal transmitted as a transmission signal and received as a reception signal into a digital signal for reception from a real channel by virtue of the fact that the decoder is designed to allocate data symbols of the digital signal to code symbols of a code space by respectively assigning a data symbol to the code symbols and to detect the code symbols on the basis of the reception signal, with the reception signal having signal edges that consist of the transition from one potential level to another potential level, and edge spacings (28) defined by the interval of time between at least two identical or predetermined different potentials of adjacent signal edges. The data symbols each have two or more than two bits of the digital signal, and the code space comprises code symbols of two groups, with each code symbol having one or a plurality of edge spacings, with
a) the edge spacing or each of the edge spacings corresponding to the minimum edge spacing in the first group, and
b) the edge spacing or one, a plurality of or all of the plurality of edge spacings corresponding to one or more integer multiples plus a fraction of an integer multiple of the minimum edge spacing in the second group.

The above object is generally achieved according to a fourth aspect of the invention by a decoding method for mapping a signal transmitted as a transmission signal and received as a reception signal into a digital signal for reception from a real channel, with data symbols of the digital signal being allocated to code symbols of a code space by respectively assigning a data symbol to the code symbols, and with the code symbols being detected on the basis of the reception signal, The reception signal has signal edges that consist of the transition from one potential level to another potential level, and edge spacings defined by the interval of time between at least two identical or predetermined different potentials of adjacent signal edges. The data symbols each have two or more bits of the digital signal, and the code space comprises code symbols of two groups, with each code symbol having one or a plurality of edge spacings, and wherein
a) the edge spacing or each of the edge spacings corresponds to the minimum edge spacing in the first group, and
b) the edge spacing or one, a plurality of, or all of the plurality of edge spacings corresponds to one or more integer multiples plus a fraction of an integer multiple of the minimum edge spacing in the second group.

The above object is generally achieved according to a fifth aspect of the invention by a system comprising a coder of the above type for mapping a digital signal into a transmission signal and a decoder of the above type for mapping a signal transmitted as a transmission signal and received as a reception signal.

The coder and decoder according to the invention, the coding method and decoding method according to the invention and the system according to the invention comprising a coder and a decoder are advantageously designed in such a manner that it is possible to increase the bit rate in comparison with the maximum bit rate which can be achieved with the non-return-to-zero method.

For this purpose, the invention provides a coder for mapping, that is to say for coding, a digital signal into a transmission signal which is transmitted in a real channel. For this purpose, the coder is designed to allocate code symbols of a code space to data symbols. The coder is also designed to generate the transmission signal on the basis of the code symbols. In this case, the transmission signal has signal edges which consist of the transition from one potential level to another potential level. The transmission signal also has edge spacings which are defined by the interval of time between two identical or different potentials of adjacent signal edges. That is to say, an edge spacing of the transmission signal is defined by the fact that, for example, a potential of the first of the adjacent signal edges of the transmission signal is predetermined and a second potential of the second of the adjacent signal edges is predetermined and the interval of time between the predetermined potentials results in the edge spacing of the transmission signal.

The data symbols each have two or more than two bits of the digital signal. The code space comprises code symbols of two different groups which differ in terms of their edge spacings, each code symbol having one or a plurality of edge spacings. The edge spacing or each of the edge spacings corresponds to the minimum edge spacing in the first group. The edge spacing or one, a plurality of or all of the plurality of edge spacings correspond(s) to one or more integer multiples of the minimum edge spacing plus a fraction of an integer multiple of the minimum edge spacing in the second group.

The advantage of the coder is that it is possible to transmit at a higher bit rate than known coders by already transmitting data symbols having two or more than two bits by means of a minimum edge spacing. Another advantage is that code symbols having one or a plurality of edge spacings, which are not limited to an integer multiple of the minimum edge spacing, that is to say the first group of code symbols, are defined. According to the invention, code symbols having one or a plurality of edge spacings, which correspond to one or more integer multiples of a minimum edge spacing plus a fraction of the minimum edge spacing and can thus be assigned to the second group of code symbols, are also generated. Edge spacings of the code symbols according to the invention are therefore not restricted to a fixed pattern, for example a clock pulse, as in known methods.

According to another advantageous design, the coder is designed to respectively allocate the same code symbol to identical data symbols. Identical data symbols are data symbols each having the same number of bits, the bits of identical data symbols having the same binary values in the same order. Identical code symbols have the same number of edge spacings, the edge spacings in identical code symbols with a plurality of edge spacings additionally each having the same orders of edge spacings.

As a result of the fact that the same data symbol is respectively allocated to the same code symbol, the code space must contain at most only a number of different code symbols corresponding to the number of different data symbols. The mapping of the digital signal to the transmission signal is thus bijective and can be implemented in a technically simple manner using a table which contains only the possible data symbols and the respective corresponding code symbols.

It is also advantageous that the coder is designed to combine each data symbol from the same number of bits. A number is thus defined and each data symbol is formed from precisely this number of bits of the digital signal.

It is advantageous that the number of different data symbols is limited by the number of defined bits. If, for instance, the number of bits is defined as two bits, four different data symbols are possible. If the number of bits is defined as four bits, for example, sixteen different data symbols are possible. In addition, the number of code symbols allocated to the data symbols is restricted and the coder must thus likewise generate fewer different code symbols and can be implemented in a technically simpler manner.

According to another preferred design, each of the code symbols consists of the same number of one or more edge spacings. For this purpose, a number is defined and each of the code symbols contains precisely the number of edge spacings corresponding to this number.

The code symbol must advantageously contain only the information relating to the data symbol and not additionally the number of edge spacings of the corresponding code symbol in order to be detected in the decoder. This is because, in the case of code symbols having a different number of edge spacings, this number of edge spacings would likewise have to be coded into the code symbols in order to provide the decoder with information relating to how many edge spacings the respective code symbol comprises.

The invention also relates to a decoder for mapping, that is to say for decoding, a signal transmitted as a transmission signal and received as a reception signal into a digital signal which is received from a real channel. For this purpose, the decoder is designed to allocate data symbols to code symbols of a code space. The decoder is also designed to detect the code symbols on the basis of the reception signal. For this purpose, the reception signal has signal edges which consist of the transition from one potential level to another potential level. Edge spacings are defined between at least two identical or different predetermined potentials of adjacent signal edges. The data symbols have two or more than two bits of the digital signal. The code space comprises code symbols of two different groups which differ in terms of their edge spacings, each code symbol having one or a plurality of edge spacings. The edge spacing or each of the edge spacings corresponds to the minimum edge spacing in the first group. The edge spacing or one, a plurality of or all of the plurality of edge spacings correspond(s) to one or more integer multiples of the minimum edge spacing plus a fraction of an integer multiple of the minimum edge spacing in the second group.

The decoder has the advantage that it can receive reception signals at a higher bit rate than conventional decoders since more than one bit is detected per edge spacing using this decoder and edge spacings which, in addition to corresponding to one or more integer multiples of the minimum edge spacing, also correspond to one or more integer multiples of the minimum edge spacing plus a fraction of the minimum edge spacing can also be detected. In particular, the code symbols from the coder according to the invention can be decoded using the decoder.

According to another preferred design, the decoder is designed to respectively allocate the same data symbol to identical code symbols. Identical code symbols have the same number of edge spacings, the edge spacings in identical code symbols with a plurality of edge spacings additionally each having the same order of edge spacings. Identical data symbols are data symbols each having the same number of bits, the bits of identical data symbols having the same binary values in the same order.

Only the number of code symbols corresponding to the number of different possible data symbols must be advantageously detected in the decoder. The mapping of the reception signal to the digital signal is thus bijective and can be implemented in a technically simple manner using a mirrored table of the table stored in the coder.

It is also advantageous that the decoder is designed to divide each data symbol into the same number of bits.

As a result of the fact that each data symbol comprises the same number of bits which is predetermined, the number of different data symbols is limited by the number of defined bits. The code symbols are accordingly also limited and the decoder must thus detect fewer different code symbols and can be implemented in a technically simpler manner.

According to another preferred design of the coder, each of the code symbols consists of the same number of one or more edge spacings.

In the decoder, there is therefore no need to acquire any information from edge spacings of a code symbol which have already been received and provide further information on edge spacings which are still to follow and could likewise belong to the currently received code symbol.

According to the invention, each code symbol has a defined edge spacing or a plurality of defined edge spacings in a defined order. For this purpose, the decoder is designed to clearly detect each code symbol by means of a defined edge spacing or a plurality of defined edge spacings in a defined order. According to one advantageous development, the decoder is also designed to detect code symbols having one or more edge spacings which differ by a tolerance value as code symbols having one or more edge spacings which do not differ by a tolerance value.

Therefore, code symbols whose edge spacing(s) differ(s) from one or more edge spacings defined in the code symbol by a tolerance value are also detected in the decoder. This is expedient when slight interference in the real channel results in signal edges being transmitted with a delay or prematurely. Code symbols are thereby still clearly detected despite the abovementioned slight interference.

The decoder is advantageously designed to identify the edge spacings which do not lead to the detection of a code symbol as transmission errors. One or more edge spacings which differ from the edge spacings of the defined code symbols by more than the tolerance value are thus not identified as defined code symbols and are marked as transmission errors.

Transmission errors are advantageously identified in order to avoid incorrectly assigning code symbols and thereby receiving incorrect digital signals. It is then possible to accordingly respond to a transmission error with further signal processing by ignoring the code symbol, for example.

An advantageous coding method for mapping a digital signal into a transmission signal for transmission in a real channel using a coder according to the invention is disclosed and claimed.

An advantageous decoding method for mapping a signal transmitted as a transmission signal and received as a reception signal into a digital signal for reception from a real channel using a decoder according to the invention is likewise disclosed and claimed.

Moreover, an advantageous system comprising a coder according to the invention for carrying out a coding method according to the invention and a decoder according to the invention for carrying out a decoding method according to the invention is disclosed and claimed.

Further advantageous embodiments emerge from the subclaims and from the exemplary embodiments explained in more detail using the accompanying drawing.

### BRIEF DESCRIPTION OF THE DRAWINGS

FIG. 1 shows a digital signal which is mapped into a transmission signal in a coder using the known non-return-to-zero method.

FIG. 2 shows the same mapping of the digital signal into a transmission signal but at a higher bit rate than in FIG. 1, as a result of which the transmission becomes error-prone.

FIG. 3 shows data and code symbols formed according to an advantageous embodiment according to the invention and their assignment to one another.

FIG. 4 shows the mapping of the digital signal from FIGS. 1 and 2 to a transmission signal using the method according to the invention, a bit rate being achieved which is higher than in FIG. 1 and simultaneously ensures error-free transmission.

FIG. 5 shows a coder according to the invention for mapping a digital signal into a transmission signal for transmission in a real channel.

FIG. 6 shows a decoder according to the invention for mapping a signal transmitted as a transmission signal and received as a reception signal into a digital signal for reception from a real channel.

FIG. 7 shows a system comprising the coder according to the invention and the decoder according to the invention.

FIG. 8 shows two sections of a transmission signal, each showing the transmission signal on the basis of different code symbols.

FIG. 9 shows data and code symbols formed according to another advantageous embodiment according to the invention, and their assignment to one another.

### DETAILED DESCRIPTION OF THE INVENTION

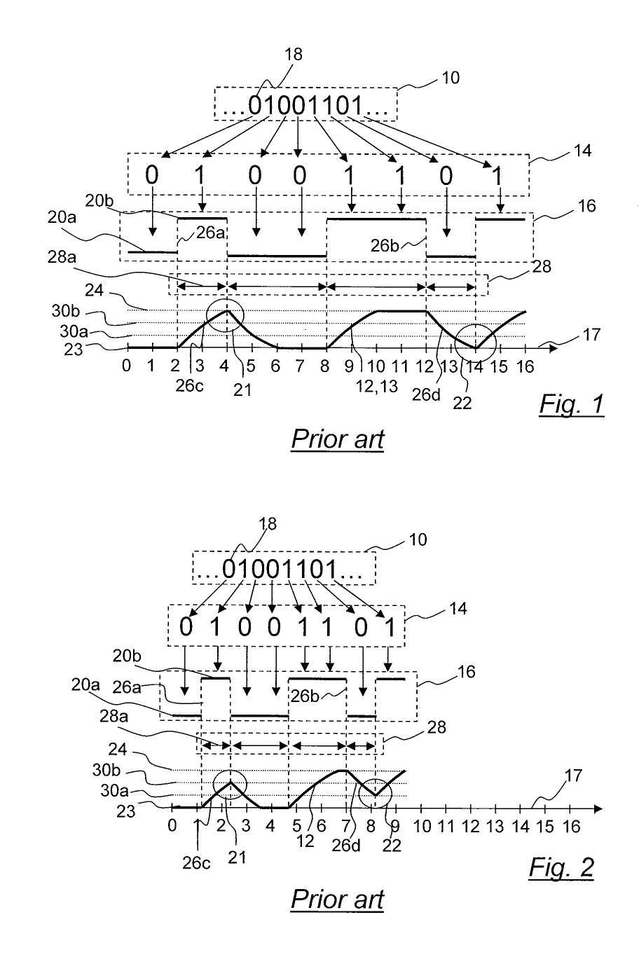

FIGS. 1 and 2 show a section of a digital signal 10 which is mapped to the transmission signal 12 for the case of coding using the known non-return-to-zero method. FIGS. 1 and 2 differ by virtue of the fact that different bit rates are respectively taken as a basis for transmission.

FIG. 1 shows a section of a digital signal 10 consisting of a bit string “01001101”, from which data symbols 14 are formed which are each allocated to the code symbols 16. A transmission signal 12 is generated from the code symbols 16 on the basis of the code symbols 16.

According to the known method, each data symbol 14 is formed from a bit 18 of the digital signal 10. Precisely two different data symbols 14 can be formed from the digital signal 10 according to the possible binary values of a bit 18. In the known method, the code space has one code symbol 16 for each data symbol 14, that is to say two different code symbols. One of the code symbols 16 has a low potential level 20a and the other code symbol 16 has a high potential level 20b.

These different code symbols 16 are accordingly allocated to the different data symbols 14 in the coder. A code symbol 16 with the low potential 20a is allocated to the data symbol 14 with the binary value “0” and a code symbol 16 with a high potential 20b is accordingly allocated to the data symbol 14 with the binary value “1”.

Signal edges 26a, 26b occur at the transition between the low potential level 20a and the high potential level 20b of the code symbols 16. However, said signal edges have a very steep profile and may be considered to be jumps without a time delay. Edge spacings 28 between the signal edges of the code symbols are defined as the interval of time between successive signal edges 26a, 26b of the code symbols.

The transmission signal 12 is generated on the basis of the code symbols 16 by directly producing the potential levels 20a, 20b in a real channel, for example. As a result, the transmission signal 12 reaches a minimum potential level 23 in areas 22 and reaches a maximum potential level 24 in other areas 21.

Signal edges 26c, 26d also arise in the case of the transmission signal 12 at the transition between the minimum potential level 23 and the maximum potential level 24 and at the transition between the maximum potential 24 and the minimum potential 23. However, in comparison with the signal edges 26a, 26b of the code symbols, the signal edges 26c, 26d of the transmission signal have a flat rise or a flat fall on account of the capacitive properties of the real channel, for example an electrical line.

The non-return-to-zero method is also based on a clock frequency. With each clock pulse of the clock frequency, the transmission signal 12 is generated on the basis of a code symbol 16 with a low potential level 20a or a high potential level 20b. This clock frequency therefore corresponds to the bit rate. A minimum edge spacing 28a is defined by the period duration corresponding to the clock frequency. This minimum edge spacing 28a corresponds to the interval of time between two signal edges 26a, 26b of the code symbols 16 which occur when successive code symbols 16 each have different potential levels. All other possible edge spacings 28 of the code symbols, in addition to the minimum edge spacing 28a, are an integer multiple of the minimum edge spacing 28a.

As stated above, the transmission signal 12 has flat signal edges 26c, 26d which, in the case of the bit rates taken as a basis in FIG. 1, reach the maximum potential level 24 and the minimum potential level 23 before a new signal edge 26c, 26d occurs owing to the minimum edge spacing 28a of the code symbols.

Decision thresholds 30a, 30b which are defined in the decoder during the non-return-to-zero method for detecting the code symbols 16 are also illustrated. In the real situation, a reception signal 13 will differ from the transmission signal 12 in terms of the amplitude, for example. However, for the sake of a simpler illustration, it is assumed in FIG. 1 that the transmission signal 12 corresponds to the reception signal 13.

The code symbols 16 are detected in the decoder on the basis of this reception signal 13. A code symbol 16 with a low potential level 20a is detected when the lower decision threshold 30a is undershot in a particular time range and a code symbol 16 with the high potential level 20b is detected when the upper decision threshold 30b is exceeded in a particular time range.

In the situation illustrated in FIG. 1, a digital signal 10 can thus be transmitted in a real channel without errors using the non-return-to-zero method and can be detected. With the bit rate taken as a basis, sixteen time units, which can be read on the time axis 17, are required for this purpose.

FIG. 2 likewise shows the mapping of a digital signal 10 to a transmission signal 12 using the non-return-to-zero method, which mapping corresponds to the mapping in FIG. 1. Identical reference symbols denote identical features in this case. However, in contrast to FIG. 1, the bit rate or the clock frequency on which the method is based has been increased. If the time axis 17 in FIG. 1 is compared with the time axis 17 in FIG. 2, it can be seen that the bit rate has been approximately doubled. The same real channel having the same capacitive effects as in FIG. 1 is likewise taken as a basis. On account of the comparable channel, the signal edges 26c, 26d of the transmission signal 12 in FIG. 2 likewise have the same flat gradient as in FIG. 1.

In contrast to FIG. 1, the minimum edge spacing 28a between the signal edges 26a, 26b of the code symbols 16 is shortened in terms of time as a result of the increase in the bit rate. Therefore, the transmission signal 12 does not reach a minimum potential level 23 in areas 22 and does not reach a maximum potential level 24 in areas 21. These areas 21, 22 occur when successive code symbols 16 have different potential levels 20a, 20b and the transmission signal 12 is generated on the basis of these different code symbols 16 because signal edges 26c, 26d of the transmission signal are generated too quickly in succession as a result.

At this bit rate, the reception signal 13 is incorrectly received in a decoder as a result of the flat gradient of the signal edges 26c, 26d of the transmission signal 12 and of the reception signal 13 in the abovementioned areas 21, 22 in which the lower decision threshold 30a is no longer undershot and the upper decision threshold 30b is no longer exceeded. Incorrect code symbols 16 would therefore be detected in the decoder in the abovementioned areas 21, 22 on the basis of the reception signal 13.

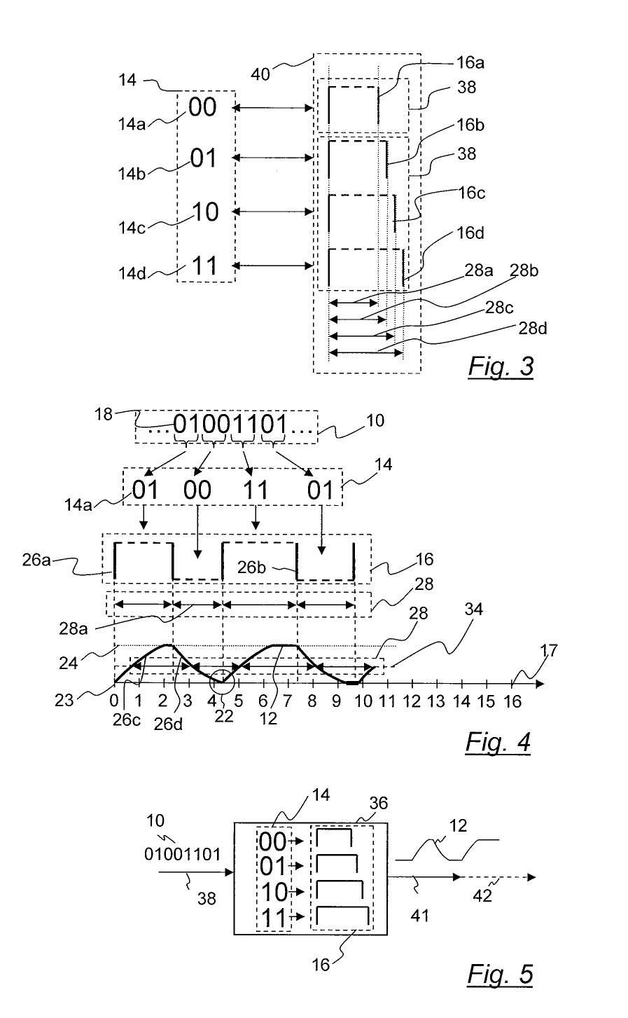

FIG. 3 shows a first advantageous design of the data and code symbols assigned to one another in the coder and decoder according to the invention.

Data symbols 14a-14d are formed from at least two bits 18. This results in exactly four different data symbols 14a-14d. Four different code symbols 16 of two groups 38, 39 are additionally formed. The code symbols 16 of the two groups 38, 39 form the code space 40. In this case, the edge spacing 28 of the upper code symbol 16a illustrated can be assigned to the first group 38 of code symbols 16. This first group 38 of code symbols 16 has code symbols 16 each with one or a plurality of edge spacings 28 each with one of the minimum edge spacing 28a. The code symbols 16 of the non-return-to-zero method also belong to this first group 38 of code symbols 16. According to the invention, however, the other code symbols 16b-16d can be assigned to a second group 39 of code symbols 16. This second group 39 comprises code symbols 16 with one or a plurality of edge spacings 28, one, a plurality of or all of the plurality of edge spacings 28 corresponding to one or more integer multiples of the minimum edge spacing 28a plus a fraction of the minimum edge spacing 28a.

The upper code symbol 16a has the minimum edge spacing 28a. The code symbol 16b below it has an edge spacing 28b which corresponds to the minimum edge spacing 28a plus a fraction of the minimum edge spacing 28a. The code symbol 16c in turn shown below the code symbol 16b has an edge spacing 28c which corresponds to the minimum edge spacing 28a plus a fraction of the minimum edge spacing 28a, the fraction being greater than in the case of the code symbol 16b shown above it. The lower code symbol 16d has an edge spacing 28d which corresponds to the minimum edge spacing 28a plus a fraction of the minimum edge spacing 28a, the fraction again being greater than in the case of the code symbol 16c shown above it. All code symbols 16a-16d differ in terms of their edge spacing 28 and can thus be clearly allocated to the data symbols 14a-14d.

In the method according to the invention, the edge spacings 28 are no longer made dependent on a clock pulse by virtue of the spacings each being an integer multiple of the period duration of the clock pulse. However, a minimum edge spacing 28a is also defined according to the invention. This minimum edge spacing defines an interval of time between the signal edges 28a, 28b of the code symbols 16, with the result that signal edges 28c, 28d of the transmission signal 12 and of the reception signal 13 which are generated from the code symbols 16 always reach a predetermined minimum potential 23 or a maximum potential 24 in the real channel before a next signal edge 28c, 28d is generated on the basis of the code symbols 16. The minimum edge spacing 28a in the method according to the invention thus still corresponds to the period duration of a clock pulse on which the known method is based and which ensures error-free transmission.

It should be pointed out that the code symbols 16 in FIG. 3 are illustrated by two signal edges 26a, 26b between which there is a high potential level 20b. However, in the method according to the invention, code symbols 16 contain only information relating to spacings of the signal edges 26a, 26b. It is irrelevant to the method according to the invention whether these spacings occur as a result of a change from low potential levels 20a to high potential levels 20b or vice versa. The transmission signal 12 is generated only on the basis of the edge spacings 28 of the code symbols 16 which successively alternate in terms of their potential level 20a, 20b.

A code symbol 16a-16d of the code space 40 is thus respectively allocated to each data symbol 14a-14d consisting of two bits. According to the invention, clear allocation of each different data symbol 14 to precisely one code symbol 16 is not prescribed. Identical data symbols 14 can also be allocated to different code symbols 16.

FIG. 4 shows the mapping according to the invention, that is to say the coding, of a digital signal 10 comparable to that in FIGS. 1 and 2 to a transmission signal 12. If the time axis 17 in FIGS. 1, 2 and 4 is compared, it can be seen in FIG. 4 that the bit rate has been approximately doubled in comparison with FIG. 2. The same real channel having the same capacitive effects as in FIGS. 1 and 2 is again taken as a basis, on account of which the signal edges 22c, 22d of the transmission signal in FIG. 4 likewise have the same gradient as in FIGS. 1 and 2. The same reference symbols in FIG. 4 denote the same features as in FIGS. 1 and 2.

FIG. 4 again shows the allocation of the code symbols 16 to the data symbols 14, the code symbols 16 and the data symbols 14 corresponding to the code symbols 16a-16d and data symbols 14a-14d described in FIG. 3. For this purpose, the data symbols 14a-14d are formed from the digital signal 10 by respectively forming each data symbol 14a-14d from two bits 18 of the digital signal 10. In a manner corresponding to the allocation illustrated in FIG. 3, the code symbols 16a-16d are allocated to these data symbols 14a-14d. The transmission signal 12 is also generated on the basis of the code symbols 16 in the real channel in FIG. 3. For this purpose, a low potential level 20a and a high potential level 20b are always alternately produced in the real channel according to the invention, each potential level 20a, 20b being produced in the real channel for the periods of time which respectively correspond to the edge spacings 28 of the code symbols 16.

In contrast to FIG. 2, however, a minimum edge spacing 28a corresponding to that in FIG. 1 is taken as a basis, as a result of which the transmission signal 12 generated on the basis of the code symbols 16 reaches the minimum potential level 22 and the maximum potential level 24 after each signal edge 22 before the transmission signal 14 is generated on the basis of the next code symbol 16.

According to the invention, with a comparable minimum edge spacing 28a in FIGS. 1 and 4, the bit rate is increased by respectively transmitting a data symbol 16a-16d having two bits 18 with an edge spacing 28, all of the defined edge spacings 28 of the code symbols 16 being shorter than twice the integer multiple of the minimum edge spacing 28a. In the case illustrated, it is assumed—as before—that the transmission signal 12 corresponds to the reception signal 13.

In the decoder, edge spacings between successive signal edges 26c, 26d of the transmission signal 12 and of the reception signal 13 are now also considered according to the invention in order to detect the code symbols 16. For this purpose, a potential 34 is predetermined in FIG. 4. It is also possible to predetermine different potentials for a rising signal edge 26c and a falling signal edge 26d of the transmission signal 12 and of the reception signal 13, for example. In the example illustrated, however, a potential is defined irrespective of whether the signal edges 26c, 26d rise or fall. That is to say, the spacing between adjacent signal edges 26c, 26d of the transmission signal 12 and of the reception signal 13 is measured in the decoder between areas in which the signal edges 26c, 26d have the predetermined potential. The code symbols 16 are therefore detected in the decoder by detecting the edge spacings 28 of the transmission signal which correspond to the code symbols 16. A data symbol 14 is accordingly respectively assigned to these code symbols in the decoder and these data symbols 14 are divided into bits 18. The digital signal 10 is finally again obtained from these bits.

It is thus clearly possible to map the reception signal 13 to the digital signal 10 in the decoder using the method according to the invention, the bit rate being increased in comparison with the non-return-to-zero method.

FIG. 5 shows the coder 36 according to the invention, the input 38 of which is supplied with the digital signal 10. The coder 36 combines bits 18 of the digital signal into data symbols 14 and allocates code symbols 16 of a code space 40 to the latter. The transmission signal 12 is generated on the basis of the code symbols 16 at the output of the coder 41.

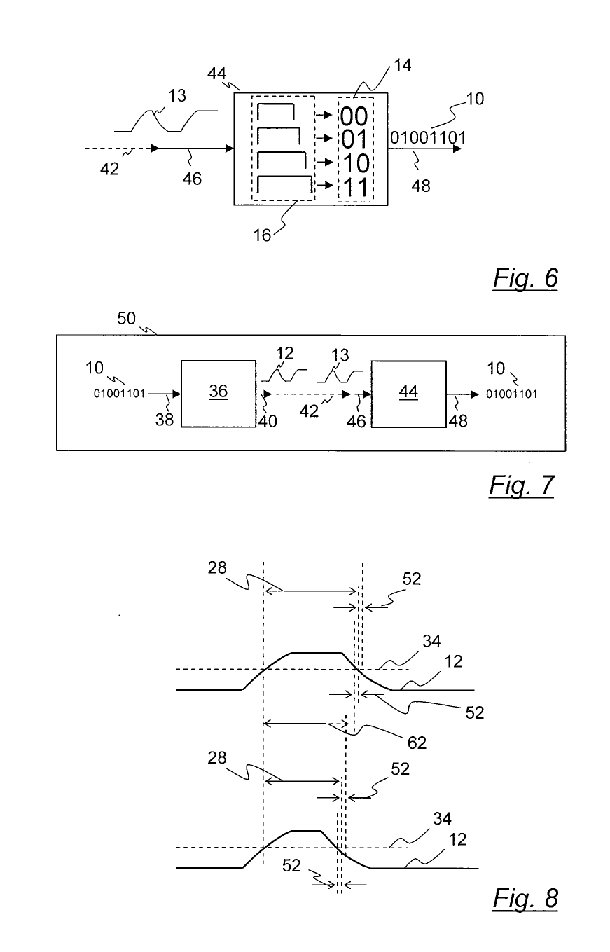

FIG. 6 shows the decoder 44 according to the invention, the input 46 of which is supplied with the reception signal 13. The decoder 44 detects the code symbols 16 of the reception signal 13 by measuring the edge spacings 28 of the reception signal 13 in one or more defined potentials 34 of successive signal edges 26c, 26d of the reception signal 13. The detected code symbols 16 of the code space 40 are then allocated to data symbols 14 containing two or more than two bits 18. The data symbols 14 are also divided into bits 18 and the digital signal 10 is obtained from the individual bits 18 and is output at the output 48 of the decoder 44.

FIG. 7 shows a system 50 comprising a coder 36 and a decoder 44, the coder 36 and the decoder 44 being connected by means of a real channel 42 between the output 41 of the coder 36 and the input 46 of the decoder 44. The digital signal 10 is supplied to the input 38 of the coder 36 and is mapped into the transmission signal 12 which is output at the output 41. The reception signal 13 corresponding to the transmission signal is supplied to the input 46 of the decoder 44, the decoder 44 mapping the reception signal back into the digital signal 10.

FIG. 8 shows two edge spacings 28 of the transmission signal 12 which are generated in the real channel 42 on the basis of the code symbols according to the invention. The edge spacings 28 can be referred to as “adjacent”. These “adjacent” signal edges correspond, for example, to the two upper code symbols 16a, 16b in FIG. 3 which thus differ, in terms of their edge spacings 28, to a lesser degree than the other code symbols 16 of a code space 40.

In order to distinguish between these two code symbols 16, two different edge spacings 28 are defined in the decoder 44. A tolerance range 52 is also defined and results in each of the code symbols 16 being clearly detected in the decoder even if the respectively detected edge spacing 28 differs from the defined edge spacing in the upward or downward direction by the tolerance value 52.

However, a tolerance value 52 is also designed only in such a manner that edge spacings 28 which are not assigned to a code symbol are defined in a time range 62. Edge spacings 28 which are smaller than the upper edge spacing 28 illustrated minus the tolerance value 52 and larger than the lower edge spacing 28 illustrated plus the tolerance value 52 are in a time range 62 and are not clearly assigned to a code symbol. These edge spacings 28 result in a code symbol 16 being identified as a transmission error.

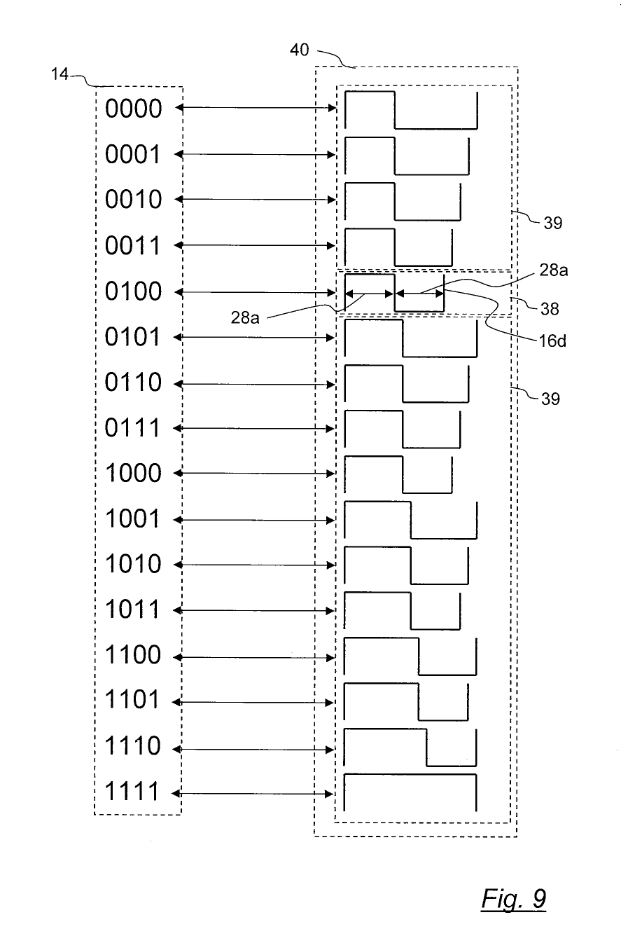

FIG. 9 shows alternatively formed data symbols 14 and code symbols 16 of a code space 40 and their allocation to one another. In this embodiment of the method according to the invention, different data symbols 14 from the combinations of four respective bits 18 are possible. In this respect, a code space 40 having sixteen code symbols 16 is accordingly illustrated. In this embodiment, all code symbols, apart from the lower code symbol 16, have two edge spacings 28. In contrast, the lower code symbol 16 has only one edge spacing 28. All of the code symbols 16, apart from the code symbol 16e, can be assigned to the second group 39 of code symbols 16. The code symbol 16e can be assigned to the first group 38 of code symbols 16 since it comprises only edge spacings with the minimum edge spacing 28a.

Like in FIG. 4, it can also be pointed out in this case that the code symbols 16 are illustrated by signal edges 26a, 26b between which high potential levels 20b or low potential levels 20a are illustrated. However, since only the edge spacings are important in the method according to the invention, the potential levels 20a, 20b of the edge spacings 28 of the code symbols 16 could also be illustrated with the correspondingly other potential level 20a, 20b.

The coding and decoding method according to the invention can advantageously also be used in the field of underwater sound location. In this case, the electrical signals from a multiplicity of transducers are first of all preprocessed by the signal processing unit respectively assigned to the respective transducers and are converted into digital signals 10. A coder 36 provided in the respective signal processing unit maps the digital signal 10 into a transmission signal 12. The transmission signal 12 is transmitted in a real channel 42, for example an electrical line, to a central signal processing device in the hull. A decoder 44 provided in the central signal processing unit maps the signal transmitted as a transmission signal 12 and received as a reception signal 13 into a digital signal 10 again.

All of the features mentioned in the abovementioned description of the figures, in the claims and in the introductory part of the description can be used both individually and in any desired combination. The disclosure of the invention is thus not restricted to the combinations of features described and claimed. Rather, all combinations of features can be considered to have been disclosed.

What is claimed is:

1. Coder for mapping a digital signal (10) into a transmission signal (12) for transmission in a real channel (42), the coder (36) being designed to allocate code symbols (16) of a code space (40) to data symbols (14) of the digital signal (10) by respectively assigning a code symbol (16) to the data symbols (14) and to generate the transmission signal (12) on the basis of the code symbols (16), the transmission signal (12) having signal edges (26c, 26d) which consist of the transition from one potential level (20a, 20b) to another potential level (20a, 20b), and edge spacings (28) being defined by the interval of time between at least two identical or predetermined different potentials (34) of adjacent signal edges (26c, 26d),
characterized in that
the data symbols (14) each have two or more than two bits (18) of the digital signal (12), and the code space (40) comprises code symbols (16) of two groups, each code symbol (16) having one or a plurality of edge spacings (28),
a) the edge spacing (28) or each of the edge spacings (28) corresponding to the minimum edge spacing (28a) in the first group (38), and
b) the edge spacing (28) or one, a plurality of or all of the plurality of edge spacings (28) corresponding to one or more integer multiples plus a fraction of an integer multiple of the minimum edge spacing (28a) in the second group (39).

2. Coder according to claim 1,
characterized in that
the coder is designed to respectively allocate the same code symbol (16) to identical data symbols (14).

3. Coder according to claim 1 or 2,
characterized in that
the coder (36) is designed to combine each data symbol (14) from the same number of bits (18).

4. Coder according to one of the preceding claims,
characterized in that
each of the code symbols (16) consists of the same number of one or more edge spacings (28).

5. Decoder (44) for mapping a signal transmitted as a transmission signal (12) and received as a reception signal (13) into a digital signal (10) for reception from a real channel (42) by virtue of the fact that the decoder (44) is designed to allocate data symbols (14) of the digital signal (10) to code symbols (16) of a code space (40) by respectively assigning a data symbol (14) to the code symbols (16) and to detect the code symbols (16) on the basis of the reception signal (13), the reception signal (13) having signal edges (26c, 26d) which consist of the transition from one potential level (20a, 20b) to another potential level (20a, 20b), and edge spacings (28) being defined by the interval of time between at least two identical or predetermined different potentials (34) of adjacent signal edges,
characterized in that
the data symbols (14) each have two or more than two bits (18) of the digital signal (12), and the code space (40) comprises code symbols (16) of two groups, each code symbol (16) having one or a plurality of edge spacings (28),
a) the edge spacing (28) or each of the edge spacings (28) corresponding to the minimum edge spacing (28a) in the first group (38), and
b) the edge spacing (28) or one, a plurality of or all of the plurality of edge spacings (28) corresponding to one or more integer multiples plus a fraction of an integer multiple of the minimum edge spacing (28a) in the second group (39).

6. Decoder according to claim 5,
characterized in that
the decoder (44) is designed to respectively allocate the same data symbol (14) to identical code symbols (16).

7. Decoder according to claim 5 or 6,
characterized in that
the decoder (44) is designed to divide each data symbol (14) into the same number of bits (18).

8. Decoder according to one of claims 5 to 7,
characterized in that
each of the code symbols (16) consists of the same number of one or more edge spacings (28).

9. Decoder according to one of claims 5 to 8,
characterized in that
each code symbol (16) has a defined edge spacing (28) or a plurality of defined edge spacings (28) in a defined order, and the decoder (44) is designed to detect each code symbol (16) by means of a defined edge spacing (28) or a plurality of defined edge spacings (28) in a defined order and by one edge spacing (28) or a plurality of edge spacings (28) which differ by a tolerance value (50).

10. Decoder according to one of claims 5 to 9,
characterized in that
the decoder (44) is designed to identify the edge spacings (28) which do not lead to the detection of a code symbol (16) as transmission errors.

11. Coding method for mapping a digital signal (10) into a transmission signal (12) for transmission in a real channel (42), code symbols (16) of a code space (40) being allocated to data symbols (14) of the digital signal (10) by respectively assigning a code symbol (16) to the data symbols (14), and the transmission signal (12) being generated on the basis of the code symbols (16), the transmission signal (12) having signal edges (22c, 22d) which consist of the transition from one potential level (20a, 20b) to another potential level (20a, 20b), and edge spacings (28) being defined by the interval of time between at least two identical or predetermined different potentials (34) of adjacent signal edges (22c, 22d),
characterized in that
the data symbols (14) each have two or more than two bits (18) of the digital signal (12), and the code space (40) comprises code symbols (16) of two groups, each code symbol (16) having one or a plurality of edge spacings (28),
a) the edge spacing (28) or each of the edge spacings (28) corresponding to the minimum edge spacing (28a) in the first group (38), and
b) the edge spacing (28) or one, a plurality of or all of the plurality of edge spacings (28) corresponding to one or more integer multiples plus a fraction of an integer multiple of the minimum edge spacing (28a) in the second group (39).

12. Decoding method for mapping a signal transmitted as a transmission signal (12) and received as a reception signal (13) into a digital signal (10) for reception from a real channel (42), data symbols (14) of the digital signal (10) being allocated to code symbols (16) of a code space (40) by respectively assigning a data symbol (14) to the code symbols (16), and the code symbols (16) being detected on the basis of the reception signal (13), the reception signal (13) having signal edges (22c, 22d) which consist of the transition from one potential level (20a, 20b) to another potential level (20a, 20b), and edge spacings (28) being defined by the interval of time between at least two identical or predetermined different potentials (34) of adjacent signal edges (22c, 22d), characterized in that
the data symbols (14) each have two or more than two bits (18) of the digital signal (12), and the code space (40) comprises code symbols (16) of two groups, each code symbol (16) having one or a plurality of edge spacings (28),
a) the edge spacing (28) or each of the edge spacings (28) corresponding to the minimum edge spacing (28a) in the first group (38), and
b) the edge spacing (28) or one, a plurality of or all of the plurality of edge spacings (28) corresponding to one or more integer multiples plus a fraction of an integer multiple of the minimum edge spacing (28a) in the second group (39).

13. System comprising a coder (36) according to one of claims 1 to 4 for carrying out a coding method according to claim 11 and a decoder (44) according to one of claims 5 to 10 for carrying out a decoding method according to claim 12.
